(19) United States
(12) Patent Application Publication
(10) Pub. No.: US 2004/0048766 A1
(43) Pub. Date: Mar. 11, 2004

(54) Detergent mixture

(76) Inventors: Hans-Christian Raths, Monheim (DE); Karl-Heinz Schmid, Mettmann (DE); Rainer Rueben, Monheim (DE)

Correspondence Address: COGNIS CORPORATION, PATENT DEPARTMENT, 300 BROOKSIDE AVENUE, AMBLER, PA, 19002, US

(21) Appl. No.: 10/466,147

(22) PCT Filed: Jan. 9, 2002
(86) PCT No.: PCT/EP02/00127

(30) Foreign Application Priority Data
Jan. 18, 2001 (DE) 101 02 006.6

(51) Int. Cl. C11D 1/00

(52) U.S. Cl. 510/499

(57) ABSTRACT

A process for making a surfactant composition involving: (a) providing a starting mixture containing: (i) an aqueous alkali solution; (ii) at least one amino acid and/or a salt thereof; (iii) a fatty acid chloride; (iv) an acylatable surfactant precursor selected from the group consisting of a protein hydrolyzate, a polyamino acid, an aminosulfonic acid, an amino sugar, a nonionic surfactant, and mixtures thereof; and (v) up to about 15% by weight, based on the weight of the starting mixture, of a polyol component; (b) providing a stirring mechanism; and (c) reacting (ii) and (iii), with stirring, to form the surfactant composition.

### FIELD OF THE INVENTION

This invention relates to special surfactant mixtures obtained by reaction of amino acids with fatty acid halides in the presence of other acylatable compounds as surfactant precursors and/or nonionic surfactants in aqueous alkaline solution, to a process for their production and to their use as cleaning and foaming agents and as emulsifiers.

### PRIOR ART

N-acylamino acids, such as N-acyl glutamates for example, are known from the prior art as mild co-surfactants for use in cosmetic preparations. They are prepared by reaction of fatty acid chlorides with the amino group of the glutamic acid sodium salt in the presence of bases, such as NaOH for example, in aqueous medium. The disadvantage of this process is that the lipophilic fatty acid chloride is difficult to react with the hydrophilic amino acid or the basic salt in aqueous medium. Attempts have been made to eliminate this problem by adding water-miscible organic solvents such as, for example, acetone, methylethyl ketone, dioxane, polyols, tetrahydrofuran, i-propanol, t-butanol or cyclohexane. However, these solvents have to be removed from the reaction mixture in occasionally very time-consuming and expensive processes.

Accordingly, a process was to provided which would enable amino acids to be reacted with fatty acid halides without the compulsory addition of solvents and their expensive removal.

Acylation in the absence of solvents, but using intensive stirring energy, is known from European patent EP 0827950 A1. The disadvantage of this process is the vigorous foaming by which it is accompanied so that the process is unsuitable for industrial application.

The problem addressed by the present invention was to provide acylamino acids which would be obtainable by a particularly inexpensive process that would not require the addition of solvents. In addition, the problems of foaming would be solved by stirring.

### DESCRIPTION OF THE INVENTION

The present invention relates to a surfactant mixture obtained by reacting

(a) at least one amino acid or a salt thereof with

(b) fatty acid halides corresponding to formula (I):

R¹COX (I)

in which R¹ is an alkyl or alkenyl group containing 6 to 22 carbon atoms and X represents chlorine, bromine, iodine, in the presence of (c) acylatable surfactant precursors selected from the group consisting

of protein hydrolyzates, polyamino acids, aminosulfonic acid and/or amino sugars and/or

(d) nonionic surfactants

and water and alkali.

The present invention also relates to a process for the production of a surfactant mixture which is characterized in that

(a) at least one amino acid or a salt thereof is reacted with

(b) fatty acid halides corresponding to formula (I):

R¹COX (I)

in which R¹ is an alkyl or alkenyl group containing 6 to 22 carbon atoms and X represents chlorine, bromine, iodine, in the presence of

(c) acylatable surfactant precursors selected from the group consisting of protein hydrolyzates, polyamino acids, aminosulfonic acid and/or amino sugars and/or

(d) nonionic surfactants and water and alkali.

It has surprisingly been found that acylamino acids are obtainable in high yields by reacting amino acids with fatty acid halides in the presence of other acylatable compounds, such as protein hydrolyzates for example, and/or nonionic surfactants in an alkaline medium. After reaction with the fatty acid halides, these acylatable compounds also have surfactant properties and, accordingly, no longer have to be removed from the reaction mixture, but instead may be directly used as a “compound” in cosmetic preparations. This advantage is also in evidence where nonionic surfactants are added. In addition, the process according to the invention is also suitable for the industrial production of acyl glutamates because the acid chloride is emulsified in a circulation pipe incorporating a mixer. The effect of using the mixer is that over-intensive stirring with entry of air is avoided in the reactor so that problems attributable to excessive foaming do not arise.

Since no solvent or other secondary products have to be removed from the reaction mixture, the process is relatively inexpensive by comparison with the prior art. In addition, it has been found that the surfactant mixtures according to the invention not only have good cleaning and foaming properties, they are also suitable for use as emulsifiers.

Amino Acids or Salts Thereof

According to the invention, suitable amino acids or amino acid salts are any α-amino acids known from the literature which can be acylated with fatty acid halides to form N-acylamino acids. Preferred amino acids are glutamic acid, sarcosine, aspartic acid, alanine, lysine, valine, leucine, isoleucine, proline, hydroxyproline, glycine, serine, cysteine, cystine, threonine, histidine and salts thereof and, more particularly, lysine, glycine, glutamic acid, sarcosine, aspartic acid and the monosodium salts thereof. The amino acids may be used in optically pure form or as racemic mixtures.

The amino acids or their salts are used in quantities of 20 to 70, preferably 35 to 60 and more particularly 45 to 50% by weight, based on the starting mixture, i.e. before addition of the acid chloride, in the production of the surfactant mixtures in accordance with the invention.

### Fatty Acid Halides

Fatty acid halides—component (b)—corresponding to formula (I):

R¹COX (I)

in which R¹ is an alkyl or alkenyl group containing 6 to 22, preferably 8 to 18 and more particularly 12 to 16 carbon atoms and X represents chlorine, bromine or iodine, preferably chlorine, are used for the production of the surfactant mixtures according to the invention. Typical acid halides are nonanoyl chloride, decanoyl chloride, undecanoyl chloride, lauroyl chloride, tridecanoyl chloride, myristyl chloride, palmitoyl chloride, stearoyl chloride, oleoyl chloride and mixtures thereof. The fatty acid halides are used in a molar ratio of acylatable compound to acid halide of 1 to 1.5 and preferably 1.15 to 1.3% by weight in the production of the surfactant mixtures in accordance with the invention.

Acylatable Surfactant Precursors

These so-called acylatable surfactant precursors are compounds which, in the absence of a hydrophobic residue, are not actually surfactants (surfactant precursors), but—by virtue of their amino group(s) present in the molecule—can be converted into compounds with surfactant properties (acylated surfactant precursors) by acylation with fatty acid halides (component b). According to the invention, suitable acylatable surfactant precursors are protein hydrolyzates, polyamino acids, aminosulfonic acid and/or aminosugars.

The acylatable surfactant precursors are used in quantities of 0.1 to 20, preferably 1 to 10 and more particularly 3 to 6% by weight in the production of the surfactant mixtures in accordance with the invention.

Protein Hydrolyzates

Protein hydrolyzates are degradation products of animal or vegetable proteins, for example collagen, elastin, casein, algae, silk or keratin and preferably wheat, rice, soya, almond. Protein hydrolyzates in the context of the invention are degradation products of vegetable proteins such as, for example, wheat, rice, soya, sunflower, almond and potato protein; marine proteins, for example algal protein or protein from marine animals; and milk, silk and cashmere proteins, and of animal proteins, for example collagen, elastin, casein, keratin and preferably of wheat, rice, soya, sunflower, almond, potato, algal, silk and cashmere proteins and, more particularly, wheat, rice, soya, sunflower, almond and potato protein, which are obtained by acidic, alkaline and/or enzymatic hydrolysis and thereafter have an average molecular weight of 100 to 4,000, preferably 300 to 2,500 and more particularly 400 to 1,200. Although protein hydrolyzates are not actually surfactants, they can be converted into protein condensates which do have surfactant properties by acylation with fatty acid halides. Synthetically obtainable oligopeptides also fall within this claim.

Overviews of the production and use of protein hydrolyzates have been published, for example, by G. Schuster and A. Domsch in Seifen, Öle, Fette, Wachse, 108, 177 (1982) and Cosm. Toil. 99, 63 (1984), by H. W. Steisslinger in Parf. Kosm. 72, 556 (1991) and by F. Aurich et al. in Tens. Surf. Det. 29, 389 (1992). Vegetable protein hydrolyzates based on wheat gluten or rice protein, of which the production is described in German patents DE 19502167 C1 and DE 19502168 C1, are preferably used.

Polyamino Acids

Suitable polyamino acids are any polymeric amino acids containing acylatable amino groups that are known to the expert. These polyamino acids which are not themslves surfactants can be converted by acylation into compounds having surfactant properties. Polyaspartic acid with degrees of oligomerization of 2 to 10 and more particularly 2 to 5 are preferably used as polyamino acids.

Aminosulfonic Acids

Aminosulfonic acids can be converted into anionic surfactants by acylation of the amino group with fatty acid halides so that they are also suitable as acylatable surfactant precursors. According to the invention, the definition of aminosulfonic acids as acylatable surfactant precursors encompasses all aminosulfonic acids known to the expert from the literature. Methyl taurine or taurine is preferably used.

Amino Sugars

Amino sugars can be converted into anionic surfactants by acylation of the amino group with fatty acid halides so that they are also suitable as acylatable surfactant precursors. According to the invention, the definition of the amino sugars as acylatable surfactant precursors encompasses all amino sugars known to the expert from the literature. Glucamine/glucosamine or galactosamine are preferably used. Oligoamino sugars with degrees of oligomerization of 2 to 10 and more particularly 2 to 5 are also suitable.

Nonionic Surfactants

Suitable nonionic surfactants are, for example, nonionic surfactants from at least one of the following groups:

[symbol] products of the addition of 2 to 30 mol ethylene oxide and/or 0 to 5 mol propylene oxide onto linear or branched C₈₋₂₂ fatty alcohols, onto C₁₂₋₂₂ fatty acids, onto alkyl phenols containing 8 to 15 carbon atoms in the alkyl group and alkylamines containing 8 to 22 carbon atoms in the alkyl group;

[symbol] alkyl and/or alkenyl oligoglycosides containing 8 to 22 carbon atoms in the alk(en)yl group and ethoxylated analogs thereof;

[symbol] addition products of 1 to 30 mol ethylene oxide onto fatty acids;

[symbol] insertion products of 1 to 30 mol ethylene oxide into fatty acid methyl esters;

[symbol] addition products of 1 to 15 mol ethylene oxide onto castor oil and/or hydrogenated castor oil;

[symbol] addition products of 15 to 60 mol ethylene oxide onto castor oil and/or hydrogenated castor oil;

[symbol] partial esters of glycerol and/or sorbitan with unsaturated, linear or saturated, branched fatty acids containing 12 to 22 carbon atoms and/or hydroxycarboxylic acids containing 3 to 18 carbon atoms and adducts thereof with 1 to 30 mol ethylene oxide;

[symbol] partial esters of polyglycerol (average degree of self-condensation 2 to 8), polyethylene glycol (molecular weight 400 to 5,000), trimethylolpropane, pentaerythritol, sugar alcohols (for example sorbitol), alkyl glucosides (for example methyl glucoside, butyl glucoside, lauryl glucoside) and polyglucosides (for example cellulose) with saturated and/or unsaturated, linear or branched fatty acids containing 12 to 22 carbon atoms and/or hydroxycarboxylic acids containing 3 to 18 carbon atoms and adducts thereof with 1 to 30 mol ethylene oxide;

[symbol] mixed esters of pentaerythritol, fatty acids, citric acid and fatty alcohol according to DE 11 65 574 PS and/or mixed esters of fatty acids containing 6 to 22 carbon atoms, methyl glucose and polyols, preferably glycerol or polyglycerol,

[symbol] mono-, di- and trialkyl phosphates and mono-, di- and/or tri-PEG-alkyl phosphates and salts thereof,

[symbol] wool wax alcohols,

[symbol] polysiloxane/polyalkyl/polyether copolymers and corresponding derivatives,

[symbol] polyalkylene glycols and

[symbol] glycerol carbonates.

The addition products of ethylene oxide and/or propylene oxide onto fatty alcohols, fatty acids, alkylphenols or onto castor oil are known commercially available products. They are homolog mixtures of which the average degree of alkoxylation corresponds to the ratio between the quantities of ethylene oxide and/or propylene oxide and substrate with which the addition reaction is carried out. C_{12/18} fatty acid monoesters and diesters of adducts of ethylene oxide with glycerol are known as lipid layer enhancers for cosmetic formulations from DE 20 24 051 PS.

Alkyl and/or alkenyl oligoglycosides, their production and their use are known from the prior art. They are produced in particular by reacting glucose or oligosaccharides with primary alcohols containing 8 to 18 carbon atoms. So far as the glycoside unit is concerned, both monoglycosides in which a cyclic sugar unit is attached to the fatty alcohol by a glycoside bond and oligomeric glycosides with a degree of oligomerization of preferably up to about 8 are suitable. The degree of oligomerization is a statistical mean value on which the homolog distribution typical of such technical products is based.

Typical examples of suitable partial glycerides are hydroxystearic acid monoglyceride, hydroxystearic acid diglyceride, isostearic acid monoglyceride, isostearic acid diglyceride, oleic acid monoglyceride, oleic acid diglyceride, ricinoleic acid monoglyceride, ricinoleic acid diglyceride, linoleic acid monoglyceride, linoleic acid diglyceride, linolenic acid monoglyceride, linolenic acid diglyceride, erucic acid monoglyceride, erucic acid diglyceride, tartaric acid monoglyceride, tartaric acid diglyceride, citric acid monoglyceride, citric acid diglyceride, malic acid monoglyceride, malic acid diglyceride and technical mixtures thereof which may still contain small quantities of triglyceride from the production process. Addition products of 1 to 30 and preferably 5 to 10 mol ethylene oxide with the partial glycerides mentioned are also suitable.

Suitable sorbitan esters are sorbitan monoisostearate, sorbitan sesquiisostearate, sorbitan diisostearate, sorbitan triisostearate, sorbitan monooleate, sorbitan sesquioleate, sorbitan dioleate, sorbitan trioleate, sorbitan monoerucate, sorbitan sesquierucate, sorbitan dierucate, sorbitan trierucate, sorbitan monoricinoleate, sorbitan sesquiricinoleate, sorbitan diricinoleate, sorbitan triricinoleate, sorbitan monohydroxystearate, sorbitan sesquihydroxystearate, sorbitan dihydroxystearate, sorbitan trihydroxystearate, sorbitan monotartrate, sorbitan sesquitartrate, sorbitan ditartrate, sorbitan tritartrate, sorbitan monocitrate, sorbitan sesquicitrate, sorbitan dicitrate, sorbitan tricitrate, sorbitan monomaleate, sorbitan sesquimaleate, sorbitan dimaleate, sorbitan trimaleate and technical mixtures thereof. Addition products of 1 to 30 and preferably 5 to 10 mol ethylene oxide onto the sorbitan esters mentioned are also suitable.

Typical examples of suitable polyglycerol esters are Polyglyceryl-2 Dipolyhydroxystearate (Dehymuls® PGPH), Polyglycerol-3-Diisostearate (Lameform® TGI), Polyglyceryl-4 Isostearate (Isolan® GI 34), Polyglyceryl-3 Oleate, Diisostearoyl Polyglyceryl-3 Diisostearate (Isolan® PDI), Polyglyceryl-3 Methylglucose Distearate (Tego Care® 450), Polyglyceryl-3 Beeswax (Cera Bellina®), Polyglyceryl-4 Caprate (Polyglycerol Caprate T2010/90), Polyglyceryl-3 Cetyl Ether (Chimexane® NL), Polyglyceryl-3 Distearate (Cremophor® GS 32) and Polyglyceryl Polyricinoleate (Admul® WOL 1403), Polyglyceryl Dimerate Isostearate and mixtures thereof.

Examples of other suitable polyolesters are the mono-, di- and triesters of trimethylolpropane or pentaerythritol with lauric acid, cocofatty acid, tallow fatty acid, palmitic acid, stearic acid, oleic acid, behenic acid and the like optionally reacted with 1 to 30 mol ethylene oxide.

Alkyl and/or alkenyl oligoglycosides are preferably used in accordance with the invention.

The nonionic surfactants are used in quantities of 0.1 to 20, preferably 1 to 10 and more particularly 2 to 6% by weight in the production of the surfactant mixtures in accordance with the invention.

Polyols

In a preferred embodiment of the invention, 0 to 15, preferably 2 to 9 and more particularly 5 to 7% by weight of polyols such as, for example, glycerol, ethylene glycol, propylene glycol, dipropylene glycol, 1,3-butylene glycol, butane-1,2-diol, butane-1,4-diol, sorbitol, mannitol, erythritol, pentaerythritol are added as an additional component.

Process

To produce the surfactant mixture according to the invention, an aqueous at least 20, preferably >40% by weight solution of the disodium salt of the amino acid, preferably a >40% by weight aqueous disodium glutamate or disodium aspartate solution is first prepared. To this end, the corresponding quantity of at least one amino acid or amino acid salt is introduced with stirring into the reaction vessel with water and at least one aqueous alkali solution, preferably sodium hydroxide, optionally with heating to a temperature of 40 to 50° C., and the whole is stirred until a clear solution with a pH of 11.5 to 12.5 is formed. Sodium hydroxide, potassium hydroxide, sodium carbonate and ammonia in particular may be used as the aqueous alkali solution.

0.1 to 20, preferably 1 to 10 and more particularly 3 to 6% by weight of the acylatable surfactant precursor and/or 0.1 to 20, preferably 2 to 15 and/or more particularly 5 to 10% by weight of the nonionic surfactant are then added to the reaction mixture which contains 20 to 70, preferably 35 to 60 and more particularly 40 to 55% by weight of the amino acid or amino acid salt. In one particular embodiment of the invention, 0 to 15, preferably 2 to 9 and more particularly 5 to 7% by weight of polyols such as, for example, glycerol, ethylene glycol, propylene glycol, dipropylene glycol, 1,3-butylene glycol, butane-1,2-diol, butane-1,4-diol, sorbitol, mannitol, erythritol, pentaerythritol may be added as an additional component.

After cooling of the solution to ca. 10 to 20° C., fatty acid halide and at the same time alkali are slowly added in a molar ratio of acylatable compound to acid halide of 1:1 to 1:1.5 and more particularly 1:1.15 to 1:1.25%, so that the pH of the reaction mixture is kept between 11.5 and 12.5. The temperature in the reaction vessel should not exceed 15 to 25° C. Typical addition times are ca. 2 to 8 hours.

In one particular embodiment of the invention, the acid chloride is emulsified in a circulation pipe incorporating a mixer, the acid chloride being added to or before the mixer. This has the advantage over addition to the reaction vessel that the local concentration of the acid chloride is high and that a very fine emulsion can be produced. In addition, it ensures that over-vigorous foaming of the product in the reaction vessel is avoided.

After addition of the fatty acid halide, the reaction mixture is stirred in the reaction vessel for about another 2 hours at ca. 20-25° C. and subsequently heated for about another 2 hours to ca. 60-80° C., after which the reaction mixture is adjusted to the desired pH value, preferably 9-10, and the desired water content is established.

Alternatively, the reaction mixture may also be worked up by acidification and phase separation/washing or filtration/washing.

Commercial Applications

In a preferred embodiment of the invention, further quantities of the nonionic surfactants described in the foregoing may be added to the surfactant mixtures according to the invention. The surfactant mixtures according to the invention have excellent cleaning and foaming properties. In addition, they may also be used as emulsifiers. Accordingly, the present invention also relates to the use of the surfactant mixture according to the invention as an emulsifier, foaming agent and cleaner.

The surfactant mixtures according to the invention may be used in surface-active preparations such as, for example, laundry and dishwashing detergents, household cleaners and cosmetic and/or pharmaceutical preparations which may contain pearlizing waxes, consistency factors, thickeners, superfatting agents, stabilizers, silicone compounds, fats, waxes, lecithins, phospholipids, antioxidants, deodorants, antiperspirants, antidandruff agents, swelling agents, tyrosine inhibitors, hydrotropes, solubilizers, preservatives, perfume oils, dyes, other surfactants and the like as further auxiliaries and additives. Cosmetic and/or pharmaceutical cleaning preparations include, for example, hair shampoos, hair lotions, foam baths, shower baths, creams, gels, lotions, alcoholic and aqueous/alcoholic solutions and emulsions.

Waxes

Suitable waxes are inter alia natural waxes such as, for example, candelilla wax, carnauba wax, Japan wax, espartograss wax, cork wax, guaruma wax, rice germ oil wax, sugar cane wax, ouricury wax, montan wax, beeswax, shellac wax, spermaceti, lanolin (wool wax), uropygial fat, ceresine, ozocerite (earth wax), petrolatum, paraffin waxes and microwaxes; chemically modified waxes (hard waxes) such as, for example, montan ester waxes, sasol waxes, hydrogenated jojoba waxes and synthetic waxes such as, for example, polyalkylene waxes and polyethylene glycol waxes. Besides the fats, other suitable additives are fat-like substances, such as lecithins and phospholipids. Lecithins are known among experts as glycerophospholipids which are formed from fatty acids, glycerol, phosphoric acid and choline by esterification. Accordingly, lecithins are also frequently referred to by experts as phosphatidyl cholines (PCs) and correspond to the following general formula:

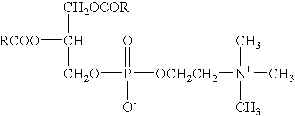

where R typically represents linear aliphatic hydrocarbon radicals containing 15 to 17 carbon atoms and up to 4 cis-double bonds. Examples of natural lecithins are the kephalins which are also known as phosphatidic acids and which are derivatives of 1,2-diacyl-sn-glycerol-3-phosphoric acids. By contrast, phospholipids are generally understood to be mono- and preferably diesters of phosphoric acid with glycerol (glycerophosphates) which are normally classed as fats. Sphingosines and sphingolipids are also suitable.

Pearlizing Waxes

Suitable pearlizing waxes are, for example, alkylene glycol esters, especially ethylene glycol distearate; fatty acid alkanolamides, especially coconut fatty acid diethanolamide; partial glycerides, especially stearic acid monoglyceride; esters of polybasic, optionally hydroxysubstituted carboxylic acids with fatty alcohols containing 6 to 22 carbon atoms, especially long-chain esters of tartaric acid; fatty compounds, such as for example fatty alcohols, fatty ketones, fatty aldehydes, fatty ethers and fatty carbonates which contain in all at least 24 carbon atoms, especially laurone and distearylether; fatty acids, such as stearic acid, hydroxystearic acid or behenic acid, ring opening products of olefin epoxides containing 12 to 22 carbon atoms with fatty alcohols containing 12 to 22 carbon atoms and/or polyols containing 2 to 15 carbon atoms and 2 to 10 hydroxyl groups and mixtures thereof.

Consistency Factors and Thickeners

The consistency factors mainly used are fatty alcohols or hydroxyfatty alcohols containing 12 to 22 and preferably 16 to 18 carbon atoms and also partial glycerides, fatty acids or hydroxyfatty acids. A combination of these substances with alkyl oligoglucosides and/or fatty acid N-methyl glucamides of the same chain length and/or polyglycerol poly-12-hydroxystearates is preferably used. Suitable thickeners are, for example, Aerosil® types (hydrophilic silicas), polysaccharides, more especially xanthan gum, guar-guar, agar-agar, alginates and tyloses, carboxymethyl cellulose and hydroxyethyl cellulose, also relatively high molecular weight polyethylene glycol monoesters and diesters of fatty acids, polyacrylates (for example Carbopols® and Pemulen types [Goodrich]; Synthalense [Sigma]; Keltrol types [Kelco]; Sepigel types [Seppic]; Salcare types [Allied Colloids]), polyacrylamides, polymers, polyvinyl alcohol and polyvinyl pyrrolidone, surfactants such as, for example, ethoxylated fatty acid glycerides, esters of fatty acids with polyols, for example pentaerythritol or trimethylol propane, narrow-range fatty alcohol ethoxylates or alkyl oligoglucosides and electrolytes, such as sodium chloride and ammonium chloride.

Superfatting Agents

Superfatting agents may be selected from such substances as, for example, lanolin and lecithin and also polyethoxylated or acylated lanolin and lecithin derivatives, polyol fatty acid esters, monoglycerides and fatty acid alkanolamides, the fatty acid alkanolamides also serving as foam stabilizers.

Stabilizers

Metal salts of fatty acids such as, for example, magnesium, aluminium and/or zinc stearate or ricinoleate may be used as stabilizers.

### Silicone Compounds

Suitable silicone compounds are, for example, dimethyl polysiloxanes, methylphenyl polysiloxanes, cyclic silicones and amino-, fatty acid-, alcohol-, polyether-, epoxy-, fluorine-, glycoside- and/or alkyl-modified silicone compounds which may be both liquid and resin-like at room temperature. Other suitable silicone compounds are simethicones which are mixtures of dimethicones with an average chain length of 200 to 300 dimethylsiloxane units and hydrogenated silicates. A detailed overview of suitable volatile silicones can be found in Todd et al. in Cosm. Toil. 91, 27 (1976).

Antioxidants

Antioxidants which interrupt the photochemical reaction chain that is initiated when UV rays penetrate into the skin may also be added. Typical examples are amino acids (for example glycine, histidine, tyrosine, tryptophane) and derivatives thereof, imidazoles (for example urocanic acid) and derivatives thereof, peptides, such as D,L-carnosine, D-carnosine, L-carnosine and derivatives thereof (for example anserine), carotinoids, carotenes (for example α-carotene, β-carotene, lycopene) and derivatives thereof, chlorogenic acid and derivatives thereof, liponic acid and derivatives thereof (for example dihydroliponic acid), aurothioglucose, propylthiouracil and other thiols (for example thioredoxine, glutathione, cysteinee, cystine, cystamine and glycosyl, N-acetyl, methyl, ethyl, propyl, amyl, butyl and lauryl, palmitoyl, oleyl, γ-linoleyl, cholesteryl and glyceryl esters thereof) and their salts, dilaurylthiodipropionate, distearylthiodipropionate, thiodipropionic acid and derivatives thereof (esters, ethers, peptides, lipids, nucleotides, nucleosides and salts) and sulfoximine compounds (for example butionine sulfoximines, homocysteinee sulfoximine, butionine sulfones, penta-, hexa- and hepta-thionine sulfoximine) in very small compatible dosages (for example pmole to μmole/kg), also (metal) chelators (for example α-hydroxyfatty acids, palmitic acid, phytic acid, lactoferrine), α-hydroxy acids (for example citric acid, lactic acid, malic acid), humic acid, bile acid, bile extracts, bilirubin, biliverdin, EDTA, EGTA and derivatives thereof, unsaturated fatty acids and derivatives thereof (for example γ-linolenic acid, linoleic acid, oleic acid), folic acid and derivatives thereof, ubiquinone and ubiquinol and derivatives thereof, vitamin C and derivatives thereof (for example ascorbyl palmitate, Mg ascorbyl phosphate, ascorbyl acetate), tocopherols and derivatives (for example vitamin E acetate), vitamin A and derivatives (vitamin A palmitate) and coniferyl benzoate of benzoin resin, rutinic acid and derivatives thereof, α-glycosyl rutin, ferulic acid, furfurylidene glucitol, camosine, butyl hydroxytoluene, butyl hydroxyanisole, nordihydroguaiac resin acid, nordihydroguaiaretic acid, trihydroxybutyrophenone, uric acid and derivatives thereof, mannose and derivatives thereof, superoxide dismutase, zinc and derivatives thereof (for example ZnSO₄), selenium and derivatives thereof (for example selenium methionine), stilbenes and derivatives thereof (for example stilbene oxide, trans-stilbene oxide) and derivatives of these active substances suitable for the purposes of the invention (salts, esters, ethers, sugars, nucleotides, nucleosides, peptides and lipids).

Swelling Agents

Suitable swelling agents for aqueous phases are montmorillonites, clay minerals, Pemulen and alkyl-modified Carbopol types (Goodrich). Other suitable polymers and swelling agents can be found in R. Lochhead's review in Cosm. Toil. 108, 95 (1993).

Hydrotropes

In addition, hydrotropes, for example ethanol, isopropyl alcohol or polyols, may be used to improve flow behavior. Suitable polyols preferably contain 2 to 15 carbon atoms and at least two hydroxyl groups. The polyols may contain other functional groups, more especially amino groups, or may be modified with nitrogen. Typical examples are

glycerol;

alkylene glycols such as, for example, ethylene glycol, diethylene glycol, propylene glycol, butylene glycol, hexylene glycol and polyethylene glycols with an average molecular weight of 100 to 1000 dalton;

technical oligoglycerol mixtures with a degree of self-condensation of 1.5 to 10 such as, for example, technical diglycerol mixtures with a diglycerol content of 40 to 50% by weight;

methylol compounds such as, in particular, trimethylol ethane, trimethylol propane, trimethylol butane, pentaerythritol and dipentaerythritol;

lower alkyl glucosides, particularly those containing 1 to 8 carbon atoms in the alkyl group, for example methyl and butyl glucoside;

sugar alcohols containing 5 to 12 carbon atoms, for example sorbitol or mannitol,

sugars containing 5 to 12 carbon atoms, for example glucose or sucrose;

amino sugars, for example glucamine;

dialcoholamines, such as diethanolamine or 2-aminopropane-1,3-diol.

Preservatives

Suitable preservatives are, for example, phenoxyethanol, formaldehyde solution, parabens, pentanediol or sorbic acid and the other classes of compounds listed in Appendix 6, Parts A and B of the Kosmetikverordnung (“Cosmetics Directive”).

Perfume oils

Suitable perfume oils are mixtures of natural and synthetic fragrances. Natural fragrances include the extracts of blossoms (lily, lavender, rose, jasmine, neroli, ylang-ylang), stems and leaves (geranium, patchouli, petitgrain), fruits (anise, coriander, caraway, juniper), fruit peel (bergamot, lemon, orange), roots (nutmeg, angelica, celery, cardamom, costus, iris, calmus), woods (pinewood, sandalwood, guaiac wood, cedarwood, rosewood), herbs and grasses (tarragon, lemon grass, sage, thyme), needles and branches (spruce, fir, pine, dwarf pine), resins and balsams (galbanum, elemi, benzoin, myrrh, olibanum, opoponax). Animal raw materials, for example civet and beaver, may also be used. Typical synthetic perfume compounds are products of the ester, ether, aldehyde, ketone, alcohol and hydrocarbon type. Examples of perfume compounds of the ester type are benzyl acetate, phenoxyethyl isobutyrate, p-tert.butyl cyclohexylacetate, linalyl acetate, dimethyl benzyl carbinyl acetate, phenyl ethyl acetate, linalyl benzoate, benzyl formate, ethylmethyl phenyl glycinate, allyl cyclohexyl propionate, styrallyl propionate and benzyl salicylate. Ethers include, for example, benzyl ethyl ether while aldehydes include, for example, the linear alkanals containing 8 to 18 carbon atoms, citral, citronellal, citronellyloxyacetaldehyde, cyclamen aldehyde, hydroxycitronellal, lilial and bourgeonal. Examples of suitable ketones are the ionones, a-isomethylionone and methyl cedryl ketone. Suitable alcohols are anethol, citronellol, eugenol, isoeugenol, geraniol, linalool, phenylethyl alcohol and terpineol. The hydrocarbons mainly include the terpenes and balsams. However, it is preferred to use mixtures of different perfume compounds which, together, produce an agreeable fragrance. Other suitable perfume oils are essential oils of relatively low volatility which are mostly used as aroma components. Examples are sage oil, camomile oil, clove oil, melissa oil, mint oil, cinnamon leaf oil, lime-blossom oil, juniper berry oil, vetiver oil, olibanum oil, galbanum oil, ladanum oil and lavendin oil. The following are preferably used either individually or in the form of mixtures: bergamot oil, dihydromyrcenol, lilial, lyral, citronellol, phenylethyl alcohol, α-hexylcinnamaldehyde, geraniol, benzyl acetone, cyclamen aldehyde, linalool, Boisambrene Forte, Ambroxan, indole, hedione, sandelice, citrus oil, mandarin oil, orange oil, allylamyl glycolate, cyclovertal, lavendin oil, clary oil, β-damascone, geranium oil bourbon, cyclohexyl salicylate, Vertofix Coeur, lso-E-Super, Fixolide NP, evernyl, iraldein gamma, phenylacetic acid, geranyl acetate, benzyl acetate, rose oxide, romillat, irotyl and floramat.

Dyes

Suitable dyes are any of the substances suitable and approved for cosmetic purposes as listed, for example, in the publication “Kosmetische Färbemittel” of the Farbstoffkommission der Deutschen Forschungs-gemeinschaft, Verlag Chemie, Weinheim, 1984, pages 81 to 106. These dyes are normally used in concentrations of 0.001 to 0.1% by weight, based on the mixture as a whole.

The total percentage content of auxiliaries and additives may be from 1 to 80% by weight and is preferably from 5 to 50% by weight and more particularly from 7 to 10% by weight, based on the particular preparation. The preparations may be produced by standard cold or hot emulsification processes or by the phase inversion temperature (PIT) method.

### EXAMPLES

### Example 1

### Preparation of a Surfactant Mixture of C₁₂-C₁₈ acyl glutamate disodium salt and C₁₂-C₁₈ acyl protein condensate based on wheat protein hydrolyzate

76 g water, 187 g (1 mol) monosodium glutamate (×1H₂O), 103 g 37% sodium hydroxide and 30 g wheat protein hydrolyzate (56% by weight active substance, 0.8% by weight acylatable nitrogen) were introduced into a reactor and cooled to 10-20° C. Before the start of the reaction, the pH was adjusted to ca. 12 with 11% sodium hydroxide. 208 g (0.95 mol) cocoyl fatty acid chloride and 308 g 11% NaOH were then simultaneously added at such a rate that the reactor temperature did not exceed 20-25° C. and the pH stayed between 11.5 and 12.5. After addition of the fatty acid chloride, the reaction mixture was stirred and simultaneously circulated (via the circulation pipe with mixer and heat exchanger) in the reactor for about another 2 hours at 20-25° C., followed by heating for about another 2 hours to 60-80° C. The reaction mixture was then cooled to room temperature and adjusted to a pH of ca. 10 by addition of dilute hydrochloric acid.

### Example 2

### Preparation of a Surfactant Mixture of C₁₂-C₁₈ Acyl Glutamate Disodium Salt and C₁₂-C₁₄ Alkyl Polyglucoside

76 g water, 187 g (1 mol) monosodium glutamate (×1H₂O), 103 g 37% sodium hydroxide and 56 g C₁₂-C₁₄ alkyl polyglucoside (50% AS) were introduced into a reactor and cooled to 10-20° C. Before the start of the reaction, the pH was adjusted to ca. 12 with 11% sodium hydroxide. 177 g (0.8 mol) cocoyl fatty acid chloride and 296 g 11% NaOH were then simultaneously added at such a rate that the reactor temperature did not exceed 20-25° C. and the pH stayed between 11.5 and 12.5. After addition of the fatty acid chloride, the reaction mixture was stirred and simultaneously circulated (via the circulation pipe with mixer and heat exchanger) in the reactor for about another 2 hours at 20-25° C., followed by heating for about another 2 hours to 60-80° C. The reaction mixture was then cooled to room temperature and adjusted to a pH of ca. 10 by addition of dilute hydrochloric acid.

### Example 3

### Preparation of a Surfactant Mixture of C₁₂-C₁₈ Acyl Glutamate Disodium Salt and C₁₂-C₁₈ Acyl Tauride Sodium salt

76 g water, 187 g (1 mol) monosodium glutamate (×1 H₂O), 103 g 37% sodium hydroxide and 24.8 g N-methyltaurine Na (50% active substance in water) were introduced into a reactor and cooled to 10-20° C. Before the start of the reaction, the pH was adjusted to ca. 12 with 11% sodium hydroxide. 211 g (0.96 mol) cocoyl fatty acid chloride and 352 g 11% NaOH were then simultaneously added at such a rate that the reactor temperature did not exceed 20-25° C. and the pH stayed between 11.5 and 12.5. After addition of the fatty acid chloride, the reaction mixture was stirred and simultaneously circulated (via the circulation pipe with mixer and heat exchanger) in the reactor for about another 2 hours at 20-25° C., followed by heating for about another 2 hours to 60-80° C. The reaction mixture was then cooled to room temperature and adjusted to a pH of ca. 10 by addition of dilute hydrochloric acid.

### Example 4

### Preparation of a C₁₂-C₁₈ Acyl Aspartate Disodium Salt and C₁₂-C₁₄ Alkyl Polyglucoside

76 g water, 133 g (1 mol) aspartic acid, 210 g 37% sodium hydroxide and 56 g C₁₂-C₁₄ alkyl polyglucoside (50% AS) were introduced into a reactor and cooled to 10-20° C. Before the start of the reaction, the pH was adjusted to ca. 12 with 11% sodium hydroxide. 177 g (0.8 mol) cocoyl fatty acid chloride and 296 g 11% NaOH were then simultaneously added at such a rate that the reactor temperature did not exceed 20-25° C. and the pH stayed between 11.5 and 12.5. After addition of the fatty acid chloride, the reaction mixture was stirred and simultaneously circulated (via the circulation pipe with mixer and heat exchanger) in the reactor for about another 2 hours at 20-25° C., followed by heating for about another 2 hours to 60-80° C. The reaction mixture was then cooled to room temperature and adjusted to a pH of ca. 10 by addition of dilute hydrochloric acid.

### Example 5

### Preparation of a Surfactant Mixture of C₁₂-C₁₈ Acyl Glutamate Disodium Salt and C₁₂-C₁₄ Alkyl Polyglucoside and 1,2-propylene Glycol

76 g water, 187 g (1 mol) monosodium glutamate (×1H₂O), 103 g 37% sodium hydroxide, 56 g C₁₂-C₁₄ alkyl polyglucoside (50% AS) and 17 g 1,2-propylene glycol were introduced into a reactor and cooled to 1020° C. Before the start of the reaction, the pH was adjusted to ca. 12 with 11% sodium hydroxide. 177 g (0.8 mol) cocoyl fatty acid chloride and 296 g 11% NaOH were then simultaneously added at such a rate that the reactor temperature did not exceed 20-25° C. and the pH stayed between 11.5 and 12.5. After addition of the fatty acid chloride, the reaction mixture was stirred and simultaneously circulated (via the circulation pipe with mixer and heat exchanger) in the reactor for about another 2 hours at 2025° C., followed by heating for about another 2 hours to 60-80° C. The reaction mixture was then cooled to room temperature and adjusted to a pH of ca. 10 by addition of dilute hydrochloric acid.

1. A surfactant mixture obtainable by reacting
(a) at least one amino acid or a salt thereof with
(b) fatty acid halides corresponding to formula (I):
R¹COX (I)
in which R¹ is an alkyl or alkenyl group containing 6 to 22 carbon atoms and x represents chlorine, bromine, iodine, in the presence of
(c) acylatable surfactant precursors selected from the group consisting of protein hydrolyzates, polyamino acids, aminosulfonic acids and/or amino sugars and/or
(d) nonionic surfactants
and water and alkali.

2. A mixture as claimed in claim 1, characterized in that glutamic acid, sarcosine, aspartic acid, alanine, valine, leucine, isoleucine, proline, hydroxyproline, glycine, serine, cysteine, cystine, threonine, histidine and salts thereof are used as the amino acids.

3. A mixture as claimed in claims 1 and/or 2 characterized in that protein hydrolyzates based on vegetable or marine proteins and on milk, silk or cashmere proteins are used as the protein hydrolyzates and polyaspartic acid with degrees of oligomerization of 2 to 10 as the polyamino acids, N-methyl taurine or taurine as the aminosulfonic acids and glucamine/glucosamine or galactosamine as the amino sugars.

4. A mixture as claimed in at least one of claims 1 to 3, characterized in that nonionic surfactants selected from the group consisting of
products of the addition of 2 to 30 mol ethylene oxide and/or 0 to 5 mol propylene oxide onto linear or branched C₈₋₂₂ fatty alcohols, onto C₁₂₋₂₂ fatty acids, onto alkyl phenols containing 8 to 15 carbon atoms in the alkyl group and alkylamines containing 8 to 22 carbon atoms in the alkyl group;
alkyl and/or alkenyl oligoglycosides containing 8 to 22 carbon atoms in the alk(en)yl group and ethoxylated analogs thereof;
addition products of 1 to 30 mol ethylene oxide onto fatty acids;
insertion products of 1 to 30 mol ethylene oxide into fatty acid methyl esters;
addition products of 1 to 15 mol ethylene oxide onto castor oil and/or hydrogenated castor oil;
addition products of 15 to 60 mol ethylene oxide onto castor oil and/or hydrogenated castor oil;
partial esters of glycerol and/or sorbitan with unsaturated, linear or saturated, branched fatty acids containing 12 to 22 carbon atoms and/or hydroxycarboxylic acids containing 3 to 18 carbon atoms and adducts thereof with 1 to 30 mol ethylene oxide;
partial esters of polyglycerol (average degree of self-condensation 2 to 8), polyethylene glycol (molecular weight 400 to 5,000), trimethylolpropane, pentaerythritol, sugar alcohols (for example sorbitol), alkyl glucosides (for example methyl glucoside, butyl glucoside, lauryl glucoside) and polyglucosides (for example cellulose) with saturated and/or unsaturated, linear or branched fatty acids containing 12 to 22 carbon atoms and/or hydroxycarboxylic acids containing 3 to 18 carbon atoms and adducts thereof with 1 to 30 mol ethylene oxide;
mixed esters of pentaerythritol, fatty acids, citric acid and fatty alcohol according to DE 11 65 574 PS and/or mixed esters of fatty acids containing 6 to 22 carbon atoms, methyl glucose and polyols, preferably glycerol or polyglycerol,
mono-, di- and trialkyl phosphates and mono-, di- and/or tri-PEG-alkyl phosphates and salts thereof,
wool wax alcohols,
polysiloxane/polyalkyl/polyether copolymers and corresponding derivatives,
polyalkylene glycols and
glycerol carbonates
are used.

5. A mixture as claimed in at least one of claims 1 to 4, characterized in that the reaction is carried out in a circulation pipe incorporating a mixer.

6. A mixture as claimed in at least one of claims 1 to 5, characterized in that polyols selected from the group consisting of glycerol, ethylene glycol, propylene glycol, dipropylene glycol, 1,3-butylene glycol, butane-1,2-diol, butane-1,4-diol, sorbitol, mannitol, erythritol, pentaerythritol are used as an additional component.

7. A process for the production of a surfactant mixture, characterized in that
(a) at least one amino acid or a salt thereof is reacted with
(b) fatty acid halides corresponding to formula (I):
R¹COX (I)
in which R¹ is an alkyl or alkenyl group containing 6 to 22 carbon atoms and X represents chlorine, bromine, iodine, in the presence of
(c) acylatable surfactant precursors selected from the group consisting of protein hydrolyzates, polyamino acids, aminosulfonic acid and/or amino sugars and/or
(d) nonionic surfactants
and water and alkali.

8. The use of the surfactant mixture claimed in claim 1 as a cleaner.

9. The use of the surfactant mixture claimed in claim 1 as a foaming agent.

10. The use of the surfactant mixture claimed in claim 1 as an emulsifier.
